(19) United States
(12) Patent Application Publication
(10) Pub. No.: US 2024/0330874 A1
(43) Pub. Date: Oct. 3, 2024

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventors: Iwao NITTA, Nagoya-shi (JP); Teruyoshi FUJIWARA, Toyota-shi (JP); Ryota SUZUKI, Osaka (JP)

(73) Assignee: TOYOTA JIDOSHA KABUSHIKI KAISHA, Toyota-shi (JP)

(21) Appl. No.: 18/544,983

(22) Filed: Dec. 19, 2023

(30) Foreign Application Priority Data
Mar. 28, 2023 (JP) 2023-052268

(51) Int. Cl. G06Q 10/30; G06Q 10/08

(52) U.S. Cl. CPC G06Q 10/30; G06Q 10/08

(57) ABSTRACT

The information processing device is a device that can access first information regarding the traceability of the products of each company included in the supply chain and second information indicating the relationship between the products of each company included in the target product. The control unit of the information processing device obtains the update deadline of the first information. The control unit of the information processing device references the second information to specify a plurality of included products included in the target product and a plurality of first accounts each having an authority to update the first information for each of the plurality of included products. The control unit then notifies each identified first account of a request for updating the first information by the update deadline.

### CROSS-REFERENCE TO RELATED APPLICATION

This application claims priority to Japanese Patent Application No. 2023-052268 filed on Mar. 28, 2023, incorporated herein by reference in its entirety.

### BACKGROUND

### 1. Technical Field

The present disclosure relates to an information processing device and an information processing method.

### 2. Description of Related Art

Japanese Unexamined Patent Application Publication No. 2004-171146 (JP 2004-171146 A) discloses an inter-company data communication system in which a supply chain made up of a plurality of companies and a management server that manages data between the companies that make up the supply chain are connected via a communication line. In the inter-company data communication system disclosed in JP 2004-171146 A, the management server includes a contract database that stores company information on companies that have concluded a contract and a unique contract ID corresponding to the contract, a transaction product database that stores product information on products for which the contract has been concluded, and a transaction condition database that stores individual information on the vendor side and the customer side for each unique contract ID with which the contract has been concluded. In the inter-company data communication system, the management server searches the individual information on the vendor side and the customer side stored in the transaction condition database using the unique contract ID of the concluded contract as a key, and translates codes of the individual information on the vendor side and the customer side.

### SUMMARY

The present disclosure has an object to provide technology capable of efficiently collecting the latest information about traceability through the entire supply chain.

A first aspect of the present disclosure provides an information processing device capable of accessing first information about traceability of products of each company included in a supply chain and second information indicating a relationship among products of the company included in a target product, the information processing device including a control unit configured to: acquire an update deadline for the first information; reference the second information to specify a plurality of included products included in the target product and a plurality of first accounts each having an authority to update the first information for each of the plurality of included products; and notify each of the specified first accounts of a request to update the first information by the update deadline.

A second aspect of the present disclosure provides an information processing method executed by a computer capable of accessing first information about traceability of products of each company included in a supply chain and second information indicating a relationship among products of the company included in a target product, the information processing method including: acquiring an update deadline for the first information; referencing the second information to specify a plurality of included products included in the target product and a plurality of first accounts each having an authority to update the first information for each of the plurality of included products; and notifying each of the specified first accounts of a request to update the first information by the update deadline.

With this disclosure, it is possible to efficiently collect the latest information about traceability through the entire supply chain.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an information processing system;

FIG. 2 is a diagram illustrating an example of the relationship between products supplied by the supply chain;

FIG. 3 is a block diagram schematically showing an example of the software configuration of the server;

FIG. 4 is a diagram showing an example of a table structure of tree information held in a tree information database;

FIG. 5 is a diagram showing an example of the table structure of traceability information held in the traceability information database;

FIG. 6 is a flowchart of the first information processing executed by the control unit of the server;

FIG. 7 is a flowchart of second information processing executed by the control unit of the server; and

FIG. 8 is a flowchart of the third information processing executed by the control unit of the server.

### DETAILED DESCRIPTION OF EMBODIMENTS

Consider a case where a product is supplied by a supply chain that includes multiple companies. In such a supply chain, there is a desire to obtain traceability information, such as the total amount of greenhouse gases emitted during the manufacturing of final products. To achieve this, it is necessary to collect traceability information, such as the amount of greenhouse gases emitted in the production of intermediate products, from multiple companies included in the supply chain.

In conventional systems, in order to collect information regarding traceability, it was necessary to exchange information between multiple companies included in the supply chain. For example, one possible method would be to relay a request for each company to input traceability information from the downstream side of the supply chain to the upstream side. However, when such a method is adopted, it takes time for information to spread, and there may be a problem that it is difficult to efficiently collect information regarding traceability. The information processing device according to the first aspect of the present disclosure solves such problems.

An information processing device according to a first aspect of the present disclosure is a device that can access first information and second information. Here, the first information is information regarding the traceability of products of each company included in the supply chain. Further, the second information is information indicating the relationship between the products of each company included in the target product. The control unit of the information processing device according to the first aspect of the present disclosure acquires the update deadline of the first information. In addition, by referring to the second information, the control unit of the information processing device is configured to update the plurality of inclusive products included in the target product and the plurality of inclusive products each having update authority for the first information of each of the plurality of inclusive products. Identify the first account. The control unit then notifies each identified first account of a request for updating the first information by the update deadline.

As explained above, the information processing device specifies the first account based on the second information. Then, the information processing device requests the first account to update the first information about the included products. Thereby, it is possible to have each company update the first information without using the method described above in which a request for inputting traceability information (first information) is relayed between companies. As a result, it is possible to streamline the collection of the latest information on traceability throughout the supply chain.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### EMBODIMENT

### System Overview

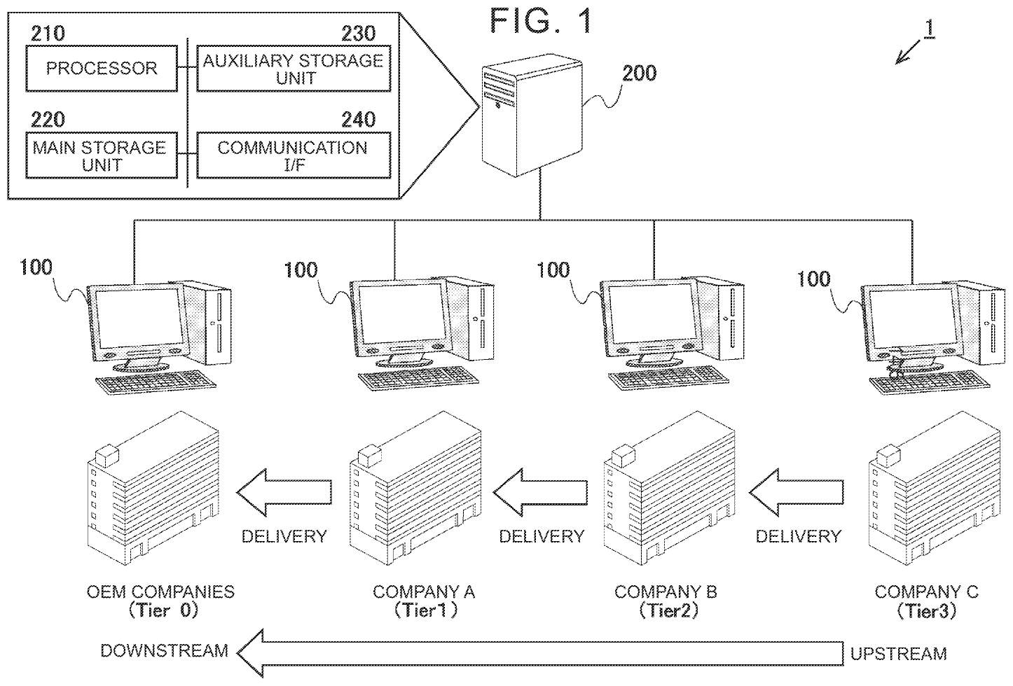

An information processing system 1 in this embodiment will be described based on FIG. 1. FIG. 1 is a diagram schematically illustrating a configuration of an information processing system 1. The information processing system 1 includes a plurality of company terminals 100 and a server 200. In the information processing system 1, a company terminal 100 and a server 200 are interconnected via a network. For example, a Wide Area Network (WAN), which is a world-wide public communication network such as the Internet, may be adopted as the network.

First, an example of a supply chain structure will be explained. In the example of FIG. 1, the supply chain includes an original equipment manufacturer (OEM) company and multiple supplier companies (Companies A, B, and C). OEM companies are companies that assemble final products. Further, a supplier company (a company that is a supplier) is, for example, a company that supplies parts, materials, assemblies, etc. for manufacturing a final product. Each supplier company produces multiple products and delivers the products to companies located one level below. Multiple companies repeat this process, and the final product is assembled in the final process. Note that the structure of the supply chain does not need to be limited to this example. Companies forming the supply chain may be determined as appropriate depending on the embodiment. In another example, the supply chain may include companies that transport, import, store, wholesale, etc. products.

In this embodiment, the side that delivers products in a certain hierarchy is called the upstream side, and the side that purchases the products and produces new products is called the downstream side. In this specification, companies located on the upstream side are referred to as upstream companies, and companies located on the downstream side are referred to as downstream companies. Furthermore, products produced by upstream companies are referred to as upstream products, and products produced by downstream companies are referred to as downstream products. Downstream products include upstream products.

Furthermore, in this specification, a hierarchy included in a supply chain is referred to as a tier. Tier 0 is the lowest layer (corresponding to OEM companies) where the final product is assembled, and as you progress through Tiers 1, 2, and 3, you move upstream. Depending on the layer of focus, downstream companies may become upstream companies. For example, company B located in Tier 2 is a downstream company in relation to Tier 3, but is an upstream company in relation to Tier 1. In this way, the definitions of upstream and downstream companies can change depending on the hierarchy.

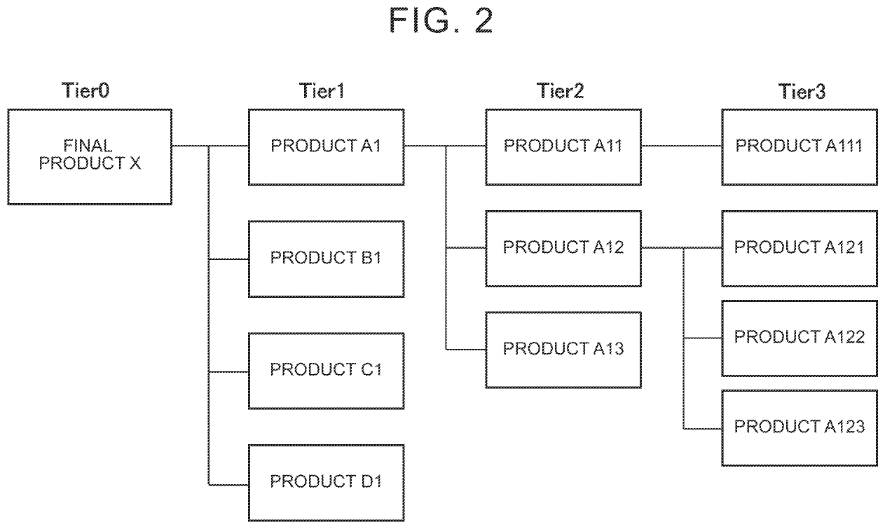

FIG. 2 is a diagram illustrating an example of the relationship between products supplied by the supply chain. In FIG. 2, the supply relationship of a plurality of products constituting the final product X is shown by a tree diagram. In the example shown in FIG. 2, final product X is produced by assembling products A1, B1, C1, and D1. Further, product A1 is produced by assembling products A11, A12, and A13. In this way, the relationship between the multiple products that make up the final product X can be represented by a tree diagram in which each product is a node. In this embodiment, relationships between a plurality of products are maintained using tree information, which will be described later. Tree information is an example of second information.

In the example of FIG. 2, company A located in Tier 1 produces products A1, B1, C1, and D1, and delivers each product to an OEM company located in Tier 0. Company B located in Tier 2 produces products A11, A12, and A13, and delivers each product to Company A located in Tier 1. Company C located in Tier 3 produces products A111, A121, A122, and A123, and delivers each product to Company B located in Tier 2. Note that a plurality of companies may be located in each tier, and products produced by each company may be delivered to an upstream company (a company in one tier smaller).

Final product X may be any product. In one example, final product X may be a battery. The final product X is, for example, a battery mounted on a vehicle. The battery mounted on the vehicle may be a battery that supplies electricity to a motor that drives the vehicle. The battery mounted on the vehicle may be a battery used as an auxiliary battery. Further, the final product X may be, for example, a stationary storage battery.

### Corporate Terminal

The company terminal 100 is a terminal related to each supplier company. The company terminal 100 receives input of product information about products produced by each company. The company terminal 100 transmits product information to the server 200 via the network. At this time, the company terminal 100 can receive input of product information and transmit product information by logging into the information processing system 1 using an account allocated to each company. In other words, each company is given an account that has the authority to update product information. Further, the company terminal 100 can receive various information from the server 200 by logging into the information processing system 1 using an account allocated to each company.

The product information includes information regarding traceability (hereinafter also referred to as traceability-related information). Traceability related information is an example of first information. In one example, the traceability-related information may include at least one of greenhouse gas emissions when a company produces a product, a recycling rate of a given raw material used in the product, and information regarding due diligence. Furthermore, the product information may further include an identifier (company ID) for identifying the company that produces the product, and an identifier (product ID) for identifying the product.

Information related to greenhouse gas emissions is information indicating the amount of greenhouse gases emitted when a company produces a product. In one example, the amount of greenhouse gas emissions included in the target company's product information indicates the amount of greenhouse gases emitted by the target company, and the amount of greenhouse gases emitted upstream from the target company until the upstream product is obtained need not be included. The predetermined raw materials include, for example, lithium, nickel, cobalt, lead, and graphite. In one example, the information regarding the recycling rate of a given raw material may include the total amount of the given raw material used in the production process (total of virgin material and recycled material) and the total amount of recycled material. In another example, the information regarding the recycling rate of a given raw material may include the total amount of virgin material and the total amount of recycled material of the given raw material utilized in the production process. Further, the information related to due diligence may include at least one of a score related to due diligence and information related to due diligence (for example, a certificate, etc.).

Input and transmission of product information may be performed, for example, by an operator such as an employee of each company. The company terminal 100 transmits product information about the product to the server 200 via the network.

### Server

The server 200 is a device for managing information (product information) on products produced by each company included in the supply chain. As a method for collecting the latest (current) information regarding traceability using the server 200, one possible method is to identify each company included in the supply chain through individual communication between companies, from the most downstream company to the most upstream company in the supply chain, and to notify each identified company of the update request of the product information. However, if such a method is adopted, it is assumed that there will be a problem that it will take time and effort to collect the latest product information of each company.

Therefore, in this embodiment, the server 200 identifies an account that has the authority to update the target product information using tree information to be described later, and then sends a request to update the product information via the network. 1 notification information is sent to the specified account (company terminal 100 associated with each company). This encourages each company to update its product information. The server 200 receives information for updating product information (hereinafter sometimes referred to as “update information”) transmitted from the company terminals 100 associated with each company via the network. The server 200 then updates the product information using the received update information.

Here, the updated information may be, for example, product information itself whose internal data has been updated. Further, the update information may be, for example, information that includes only data that needs to be updated in product information.

In addition, the first notification information indicates whether there is any data that needs to be updated among the data included in the product information (e.g., greenhouse gas emissions, recycling rate of specified raw materials, due diligence information, etc.). It may also include information to be queried. In this case, if there is no data that requires updating among the data included in the product information, the update information may be information indicating that there is no data that requires updating. Details of how the server 200 transmits the first notification information to the company terminals 100 related to each company will be described later.

The server 200 includes a computer having a processor 210, a main storage unit 220, an auxiliary storage unit 230, and a communication interface (communication I/F) 240. Processor 210 is, for example, a Central Processing Unit (CPU) or a Digital Signal Processor (DSP). The main storage unit 220 is, for example, Random Access Memory (RAM). The auxiliary storage unit 230 is, for example, a read-only memory (ROM). Further, the auxiliary storage unit 230 is, for example, a Hard Disk Drive (HDD), or a disc recording medium such as a CD-ROM, a DVD disc, or a Blu-ray disc. The auxiliary storage unit 230 may be a removable medium (a portable storage medium). Examples of the removable medium include a USB memory or an SD card. The communication I/F 240 is, for example, a Local Area Network (LAN) interface board or a wireless communication circuit for wireless communication.

In the server 200, the auxiliary storage unit 230 stores an operating system (OS), various programs, various information tables, and the like. Furthermore, in the server 200, the processor 210 loads the program stored in the auxiliary storage unit 230 into the main storage unit 220 and executes it, thereby realizing various functions (software modules) as described below. However, some or all of the functions in the server 200 may be realized by a hardware circuit (hardware module) such as an ASIC or an FPGA. Note that the server 200 does not necessarily need to be realized by a single physical configuration, and may be configured by a plurality of computers that cooperate with each other. Note that, like the server 200, the company terminal 100 is also configured to include a computer.

### Software Configuration

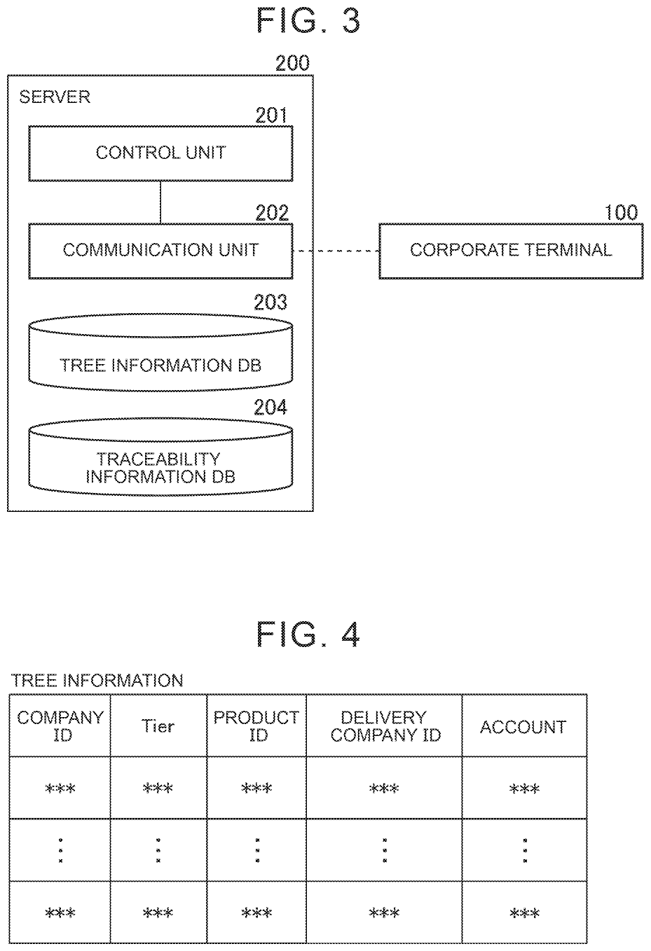

Next, the software configuration of the server 200 that constitutes the information processing system 1 will be described based on FIGS. 3 to 5. FIG. 3 is a block diagram schematically showing an example of the software configuration of the server 200. The server 200 includes a control unit 201, a communication unit 202, a tree information database 203 (tree information DB 203), and a traceability information database 204 (traceability information DB 204).

The control unit 201 is configured to execute arithmetic processing for controlling the server 200. The control unit 201 may be configured by a processor 210. The communication unit 202 is configured to connect the server 200 to a network (transmission/reception of data). The communication unit 202 may be configured by a communication I/F 240.

The tree information DB 203 is configured to hold tree information. The tree information is configured to show relationships between products of each company included in the supply chain. FIG. 4 is a diagram showing an example of a table structure of tree information held in the tree information DB 203. The tree information DB 203 may be configured by an auxiliary storage unit 230. The tree information has a company ID field, a Tier field, a product ID field, a delivery company ID field, and an account field.

The company ID field stores an identifier (company ID) for identifying each company included in the supply chain. The Tier field stores information indicating the tier in which the company corresponding to the company ID stored in the company ID field is located. The product ID field stores an identifier (product ID) for identifying a product produced by the company corresponding to the company ID stored in the company ID field. The destination company ID stores an identifier (destination company ID) for identifying the company to which the product corresponding to the product ID stored in the product ID field is delivered. The account field stores information indicating an account (an account with the authority to update product information) granted to the company corresponding to the company ID stored in the company ID field.

By referring to the tree information held in the tree information DB 203, the control unit 201 can grasp the supply relationship of a plurality of products that constitute the final product X in the supply chain. Note that the data format of the tree information may be any format as long as it is possible to grasp the supply relationship of a plurality of products constituting the final product X in the supply chain.

The control unit 201 receives, via the communication unit 202, product information from the company terminals 100 related to each company included in the supply chain. The control unit 201 stores product information about each company in the traceability information held in the traceability information DB 204. Further, the control unit 201 receives update information from the company terminals 100 related to each company included in the supply chain via the communication unit 202. The control unit 201 updates the traceability information held in the traceability information DB 204 using the received update information. That is, the control unit 201 updates product information about each company using the update information.

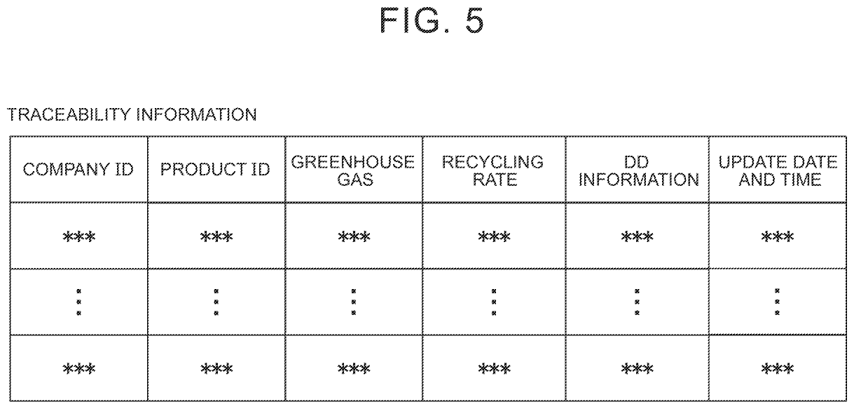

The traceability information DB 204 is configured to hold traceability information. Traceability information includes product information received from multiple companies included in the supply chain. The traceability information DB 204 may be configured by an auxiliary storage unit 230. FIG. 5 is a diagram showing an example of a table configuration of traceability information held in the traceability information DB 204. The traceability information includes a company ID field, a product ID field, a greenhouse gas field, a recycling rate field, a DD information field, and an update date and time field.

The company ID field stores a company ID for identifying the company that sent the product information. The product ID field stores the product ID included in the product information. The greenhouse gas field stores information regarding the amount of greenhouse gas emissions included in the product information. The recycling rate field stores information regarding the recycling rate of a predetermined raw material included in the product information. The DD information field stores information related to due diligence included in the product information. The update date and time field stores information indicating the date and time when the company corresponding to the company ID stored in the company ID field last sent update information.

By acquiring traceability information from the traceability information DB 204, the control unit 201 can grasp information regarding greenhouse gas emissions, recycling rate of predetermined raw materials, and due diligence for products produced by each company. Furthermore, by acquiring traceability information from the traceability information DB 204, the control unit 201 can grasp the date and time when each company last updated its product information.

The control unit 201 acquires a deadline (hereinafter sometimes referred to as an “update deadline”) by which updated traceability information (product information for each company) is required. The control unit 201 may obtain, for example, an update deadline input by an administrator of the server 200 or the like. Further, the control unit 201 may obtain an update deadline defined by a rule regarding a deadline for updating product information. Further, if updating of product information is required by law or the like, the control unit 201 may obtain the update deadline specified by the law or the like. Further, the control unit 201 may obtain update deadlines set at predetermined intervals. Further, the update deadline is, for example, the final deadline for which updated product information is required. Further, the update deadline may be a provisional deadline.

The control unit 201 acquires information that specifies the target product (hereinafter sometimes referred to as “designation information”). Here, the target product is the final product X, for example. Furthermore, the target product may be a product (intermediate product) produced by a company located upstream from the OEM company. The control unit 201 refers to the tree information held in the tree information DB 203 to identify products included in the target products specified by the specified information (hereinafter sometimes referred to as “inclusive products”). Further, the control unit 201 refers to the tree information held in the tree information DB 203 to identify a company (hereinafter sometimes referred to as a “target company”) that produces the included product. Specifically, the control unit 201 obtains the tree information, refers to the supply relationships of the plurality of products that make up the final product X, and identifies the included products and the target company.

Here, when the target product is final product X, all products produced by companies located upstream from the OEM company become included products. In addition, all companies located upstream from OEM companies will be targeted. In other words, in the example shown in FIG. 2, all companies located in Tier 1 to Tier 3 (Companies A, B, and C) are the target companies, and all products produced by Companies A, B, and C are included. Becomes a product. Further, in the example shown in FIG. 2, when the target product is product A1, product A11, product A12, product A13, product A111, product A121, product A122, and product A123 are included products. In this case, companies located in Tier 2 and Tier 3 (Companies B and C) are the target companies.

The control unit 201 refers to the account field in the tree information to identify an account associated with the target company (hereinafter sometimes referred to as a “target account”). Then, the control unit 201 transmits the first notification information to the target account by the update deadline. Here, the first notification information includes information specifying a deadline for transmitting update information to the server 200 (hereinafter sometimes referred to as a “transmission deadline”). Thereby, the company terminal 100 associated with the target company can receive a notification requesting update of product information by the transmission deadline by logging into the information processing system 1 using the target account. Here, a deadline earlier than the update deadline is set as the transmission deadline. Furthermore, the same deadline as the update deadline may be set as the transmission deadline.

Here, the control unit 201 determines the timing to transmit the first notification information (hereinafter sometimes referred to as “transmission timing”). Here, the control unit 201 determines the transmission timing to be before the update deadline. For example, the control unit 201 determines, as the transmission timing, a timing after a predetermined date and time has elapsed from the date and time when the update deadline was specified by the administrator of the server 200 or the like.

Further, the control unit 201 may determine the transmission timing to be a predetermined date and time before the transmission deadline. Further, the transmission timing may be a date and time specified by the administrator of the server 200 or the like, and may be a day before the update deadline. Further, the transmission timing may be a timing at which an update deadline is specified. In this case, when the update deadline is input by the administrator or the like of the server 200, the control unit 201 immediately starts executing the process for transmitting the first notification information.

The control unit 201 receives update information as a response to a request for updating product information based on the first notification information. In this way, the control unit 201 receives a response from the target account to a request regarding updating of product information based on the first notification information. On the other hand, updated product information may not be updated by a predetermined timing. Here, the predetermined timing is, for example, a transmission deadline. Further, the predetermined timing may be a predetermined time before or after the transmission deadline. Further, the predetermined timing may be an update deadline. Furthermore, the predetermined timing may be a predetermined time before or after the update deadline.

The control unit 201 determines, at a predetermined timing, whether there is a target company that has not sent update information (hereinafter sometimes referred to as a “non-sending company”). Specifically, the control unit 201 refers to the update date and time field in the traceability information held in the traceability information DB 204 to determine whether there is a company that has not yet sent the information. At this time, the control unit 201 determines that there are unsent companies if there is a target company whose date and time when the target company last sent update information stored in the update date and time field is earlier than the date and time when it sent the first notification information. In addition, the control unit 201 determines that there is no unsent company in all of the target companies stored in the update date and time field, if the date and time when the update information was last sent is later than the date and time when the first notification information was sent.

When the control unit 201 determines that there is a non-sending company, it specifies a company located downstream of the non-sending company (hereinafter sometimes referred to as a “target downstream company”). Specifically, the control unit 201 identifies the target downstream company by referring to the tree information held in the tree information DB 203. Here, the target downstream company is typically a company located downstream of the non-sending company and whose Tier is one smaller than the Tier of the target company. The target downstream company may be a company whose Tier is one or more smaller than the Tier of the target company. Furthermore, the control unit 201 refers to the tree information and identifies the account of the target downstream company.

The control unit 201 sends information (hereinafter sometimes referred to as “second notification information”) for making a request to a target downstream company's account (hereinafter sometimes referred to as “target downstream account”) to request a non-sending company to send update information. Then, the target downstream company located downstream of the non-sending company that has not sent updated information at a predetermined timing will request the non-sending company to send updated information, thereby preventing the non-sending company from sending updated information. Prompted.

Further, the control unit 201 may store a flag indicating that the target company (non-sending company) corresponding to the non-sending account is a non-sending company in the traceability information held in the traceability information DB 204. That is, the control unit 201 may store, in the traceability information held in the traceability information DB 204, a flag indicating that a non-transmitting company has not transmitted updated information. Thereby, the control unit 201 can make various notifications to the accounts of companies that have not sent update information by referring to the flag indicating that update information has not been sent.

### First Information Processing

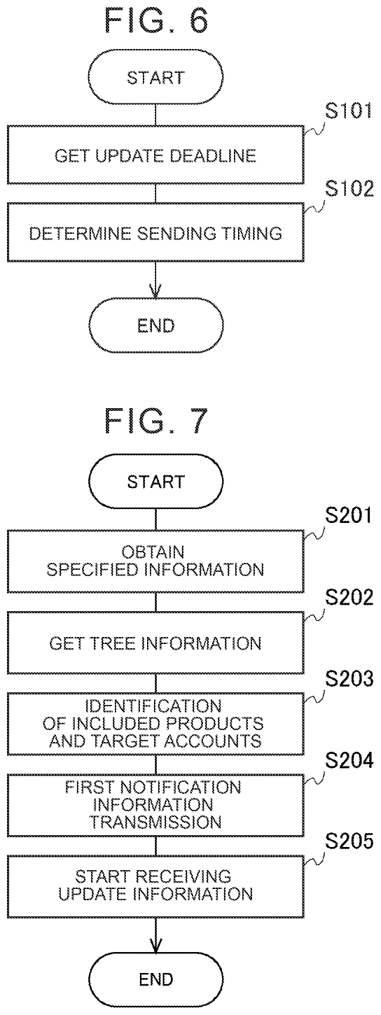

Next, the first information processing executed by the control unit 201 of the server 200 in the information processing system 1 will be described based on FIG. 6. FIG. 6 is a flowchart of the first information processing executed by the control unit 201 of the server 200. The first information processing is processing for determining transmission timing. The first information processing starts to be executed when an update deadline is specified.

In the first information processing, an update deadline is first obtained in S101. Next, in S102, transmission timing is determined. Then, the first information processing is ended.

### Second Information Processing

Next, the second information processing executed by the control unit 201 of the server 200 in the information processing system 1 will be described based on FIG. 7. FIG. 7 is a flowchart of the second information processing executed by the control unit 201 of the server 200. The second information processing is processing for transmitting the first notification information. The second information processing starts to be executed when the transmission timing arrives.

In the second information processing, first in S201, designation information is acquired. Next, in S202, tree information is acquired from the tree information DB 203. Next, in S203, the tree information is referenced to identify the included products included in the target product and the target account corresponding to the included products. Next, in S204, first notification information is sent to the target account. Next, in S205, reception of update information is started in order to receive the update information. Then, the second information processing is ended.

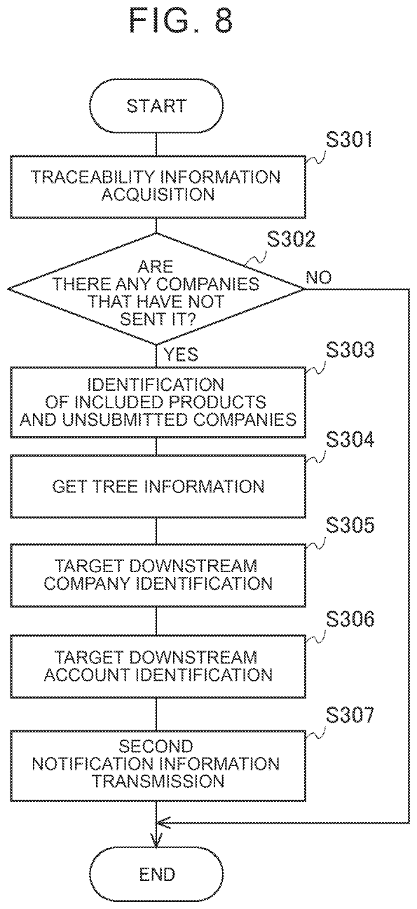

Next, the third information processing executed by the control unit 201 of the server 200 in the information processing system 1 will be described based on FIG. 8. The third information process is a process of transmitting second notification information for requesting a company that has not yet sent update information to the target downstream account. FIG. 8 is a flowchart of the third information processing executed by the control unit 201 of the server 200. The third information processing starts to be executed when a predetermined timing arrives.

In the third information processing, traceability information is first obtained from the traceability information DB 204 in S301. Next, in S302, traceability information is referred to determine whether an unsent account exists. Specifically, if there is a target account whose date and time when the last update information was sent, which is stored in the update date and time field, is earlier than the date and time when the first notification information was sent, the control unit 201 determines that an unsent account exists. If a negative determination is made in S302, there is no unsent account, so the third information processing is ended.

If an affirmative determination is made in S302, the traceability information is referred to in S303 to identify the non-sending company and the included products produced by the non-sending company. Next, in S304, tree information is acquired. Next, in S305, the tree information is referred to and the target downstream company is identified. Next, in S306, the target downstream account is identified by referring to the traceability information. Next, in S307, second notification information is sent to the target downstream account. Then, the third information processing is ended.

At this time, if the unsent company has not sent the update information even after a predetermined date and time has passed from the predetermined timing, the server 200 may execute a process of sending the second notification information again to the target downstream account. This process may be repeated if the non-sending company has not sent updated information. In this case, the server 200 may shorten the execution interval depending on the number of times the process is performed. By repeatedly transmitting the second notification information to the target downstream account, it becomes possible to more strongly urge companies that have not yet transmitted the update information to transmit the update information.

As explained above, in the information processing system 1 according to the present embodiment, a target account is specified. Then, in the information processing system 1, a request is made to the target account to send updated information about the included products. This makes it possible to directly request target companies to send updated information without having to relay notifications requesting the sending of product information to the server 200 between companies, and makes it possible to efficiently collect traceability information.

Furthermore, if the target company does not respond to the notification, the server 200 transmits second notification information to the target downstream account. This prompts the target downstream company to request the target company corresponding to the unsent account to send updated information. In this case, since the target downstream companies are customers of the target company, the target companies corresponding to the unsent accounts will be strongly encouraged to send updated information. As a result, it is possible to reliably collect the latest information on traceability throughout the supply chain.

### MODIFIED EXAMPLES

In this embodiment, the server 200 holds tree information in the tree information DB 203 in the server 200. However, the server 200 does not necessarily have to hold the tree information in the tree information DB 203 in the server 200. In another example, the server 200 may access information held in the company terminal 100 associated with each company that indicates the companies to which each company delivers products. Then, the server 200 may acquire the tree information by aggregating information indicating the companies to which each company delivers products. In yet another example, the product information of each company may include information (linking information) indicating a linking relationship between at least one of an upstream product and a downstream product related to the company's target product. In this case, the tree information may be composed of linking information that is held separately as product information for each company.

Further, in this embodiment, the server 200 holds traceability information in the traceability information DB 204 in the server 200. However, the server 200 does not necessarily need to hold traceability information in the traceability information DB 204 in the server 200. In this case, the server 200 may access product information about each company held in the company terminal 100 associated with each company. Then, the server 200 may acquire traceability information by aggregating product information about products of each company.

Furthermore, in this embodiment, at least part of the processing of the server 200 may be executed by a terminal of each company (typically, the most downstream company). In one example, product information may be held in each company's terminal, and the most downstream company's terminal may collect each company's product information by communicating with each company's terminal via a network. In this case, the terminal of the most downstream company may hold tree information about the target final product, and may refer to the held tree information to access each company's terminal and collect product information (traceability-related information). Alternatively, the terminals of the most downstream companies can be accessed sequentially from the terminals of Tier 1 companies, and by referring to the linking information, the product information of each company can be traced back to the product information of the next upstream company until reaching the most upstream company. Thus, product information (traceability related information) of each company up to the most upstream company may be collected.

### OTHER EMBODIMENTS

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. The non-transitory computer-readable storage medium is, for example, a disc of any type such as a magnetic disc (floppy (registered trademark) disc, or hard disk drive (HDD), etc.), an optical disc (compact disc read-only memory (CD-ROM), digital versatile disc (DVD), or Blu-ray disc, etc.), a read-only memory (ROM), a random access memory (RAM), an erasable programmable read-only memory (EPROM), an electrically erasable programmable read only memory (EEPROM), a magnetic card, a flash memory, or any type of medium suitable for storing electronic commands such as an optical card.

What is claimed is:

1. An information processing device capable of accessing first information about traceability of products of each company included in a supply chain and second information indicating a relationship among products of the company included in a target product, the information processing device comprising a control unit configured to:
acquire an update deadline for the first information;
reference the second information to specify a plurality of included products included in the target product and a plurality of first accounts each having an authority to update the first information for each of the plurality of included products; and
notify each of the specified first accounts of a request to update the first information by the update deadline.

2. The information processing device according to claim 1, wherein the control unit is further configured to:
receive a response to the request about the update from each of the first accounts; and
when the response is not received by a predetermined timing,
reference the second information to specify a second account of a second company located downstream of a first company corresponding to a first account from which the response has not been received in the supply chain for the target product, and
notify the specified second account of a request to request the first company to update the first information.

3. The information processing device according to claim 1, wherein the first information is configured to include at least one of an amount of greenhouse gas emissions, a recycling rate of a predetermined raw material, and information about due diligence.

4. The information processing device according to claim 1, wherein the target product is a product related to batteries.

5. An information processing method executed by a computer capable of accessing first information about traceability of products of each company included in a supply chain and second information indicating a relationship among products of the company included in a target product, the information processing method comprising:
acquiring an update deadline for the first information;
referencing the second information to specify a plurality of included products included in the target product and a plurality of first accounts each having an authority to update the first information for each of the plurality of included products; and
notifying each of the specified first accounts of a request to update the first information by the update deadline.
